(19) United States
(12) Patent Application Publication
(10) Pub. No.: US 2009/0264270 A1
(43) Pub. Date: Oct. 22, 2009

(54) Method for Production of Cut-Outs Made From Cardboard or Cardboard-Like Materials

(76) Inventors: Detlef Hulverscheidt, Remscheid (DE); Manfred Pszak, Wermelskirchen (DE)

Correspondence Address: Scott R. Foster;Pandiscio & Pandiscio, 470 Totten Pond Road, Waltham, MA, 02451-1914, US

(21) Appl. No.: 12/087,140

(22) PCT Filed: Jan. 5, 2007
(86) PCT No.: PCT/EP2007/000049

§ 371 Date: Oct. 6, 2008

(30) Foreign Application Priority Data
Jan. 12, 2006 (DE) 10 2006 001 803.6

(51) Int. Cl. B31B 1/16

(52) U.S. Cl. 493/62; 493/342

(57) ABSTRACT

This invention relates to a method for the production of blanks made of cardboard or of cardboard-like material and a device suitable for it.

An integrated plotter module by which the individual workpieces are positioned in the longitudinal direction by the transfer drive is an important feature.

This invention relates to a method for the production of blanks made from cardboard or cardboard-like materials with the features of the main claim and device for implementing the method pursuant to the preamble of Claims 4.

Such a method conforms to the prior art in the scope of the features that had been disclosed by EU 04 739 844.

It is possible by such a method also to add to the cardboard blank, in addition to the longitudinal or transverse machining lines customary for cardboard blanks, for example cutting, scoring, perforating, punching, and folding lines, machining lines that run neither exclusively in the longitudinal direction nor exclusively in the transverse direction.

The longitudinal direction of the workpiece or cardboard blank means the direction that is defined by the direction of motion of the transfer drive with the assistance of which the workpieces are transported from the intake area of the machine through the individual machining steps.

If the longitudinal directions of all of the successive machining modules to be passed through lie on a single straight line, then we speak of a so-called in-line machine (for example, see the Klett Catalog).

Besides printing, punching, and perforating modules, etc., all of the individual subassemblies necessary for producing such cardboard blanks within which the cardboard blanks are subjected to a particular type of machining belong to the machining modules.

As previously disclosed by the aforementioned EU 04 739 844, there are a number of standardized cardboard blanks that need machining that runs diagonally to the longitudinal direction, so that the present invention has the basic task of perfecting the method previously disclosed so that the machining directions that run neither exclusively longitudinally nor exclusively transversely can be run with simplified effort by the particular suitable tool.

This task is accomplished with the features of the main claim.

A device suitable for this is described with the features of Claim 4.

The invention is based on the basic concept of designing the plotter mechanism or the plotter module so that it can be moved only in the transverse direction, while the necessary longitudinal machining is accomplished not by the plotter module itself but by the correspondingly designed transfer device for transporting the cardboard blank through the machine.

The transfer device is designed for this purpose in such a way that it can travel both forward and backward in the longitudinal direction, preferably through control electronics, at speeds as highly variable as possible.

The cardboard blank entrained by the transfer drive is therefore moved beneath the machining head of the plotter device solely by the transfer drive of the machine, while the machining head of the plotter device is movable only transverse to the longitudinal direction.

Thus the drive motors for the transverse direction on the plotter device and for the longitudinal direction on the transfer drive only have to be combined with one another so that any desired machining direction on the cardboard blank running diagonally is made possible. This is done by variable speeds in the longitudinal and transverse directions.

This is done mathematically by vectorial addition of the particular speeds in the longitudinal direction and in the transverse direction.

The benefit of the invention lies particularly in the saving of an additional longitudinal drive in the plotter module, because the cardboard blank is fed by the transfer drive of the machine through the plotter in the longitudinal direction anyhow.

The invention has recognized this and makes use of a control based thereon, with the help of which the individual controllable drive motors are added together for both the longitudinal and the transverse directions in the sense of the mathematical addition of the particular speed components.

Therefore, it can be stated explicitly that the plotter device makes possible a drive motion of the machining head solely in the transverse direction, while the longitudinal direction in which the workpiece has to move is accomplished by the transfer drive of the processing machine.

In this way the structural length of such cardboard processing machines customary up to now can be reduced substantially.

Without departing from the basic concept of the invention, the plotter device with the machining head stopped in the transverse direction can even set up longitudinal machining lines, and with the transfer drive stopped in the longitudinal direction it can set up machining lines in the transverse direction.

In this way a substantially reduced structural cost is obtained, because in principle even the usual flat-bed dies and rotary dies can be omitted.

The plotter device pursuant to the invention is specifically also able to execute the numerous machining lines produced by flat-bed dies or rotary dies.

The cost of such a whole machine is therefore substantially reduced and so is the size of the building that the company has to provide.

A refinement is preferred in which the transfer drive for the workpiece lies exclusively on a single straight line starting beyond the intake station and preferably up to a following stacker.

In this way, a plotter module is obtained that can be easily inserted between machining lines that already exist.

To produce a diagonal machining line as stepless as possible, it is proposed also that the machining tool of the plotter device be rotatable during the machining of each individual workpiece into any arbitrary rotational position that results from the vectorial addition of the speeds in the longitudinal and transverse directions at any time during the machining.

In this way, the machining tool is always exactly parallel to the machining line that it is to produce, so that with appropriately fine digital preparation of the control data, even visually circular contours can be cut out, or the like. In this case it is also possible, instead of a single plotter device, to provide a plurality of such plotter modules in line, of which a first plotter module produces cuts, for example, the next plotter module produces perforations, and the third plotter module produces score lines, etc.

It is important for all such plotter modules for the components of motion of the machining head to be accomplished only in the transverse direction, while the longitudinal direction follows from motion of the workpiece by means of the transfer drive.

The invention is known to the extent that it operates solely by the relative motion between machining head and workpiece, and consequently does without a separate longitudinal drive on the plotter device, which is replaced, of course, by the appropriately designed variable transfer drive.

The individual machining of each workpiece may definitely take more time in the plotter module than in the other modules.

It is proposed for this purpose that at least the speeds of the preceding machining modules be reducible so that enough time is available for machining in the plotter module.

The speeds can be reduced even to a full stop.

In addition, the machining head on the plotter module has a vertical axis of rotation, around which it can be mounted in any desired rotational position by means of a separate drive.

The particular rotational position needed is found by the vectorial addition of the speeds in the longitudinal and transverse directions.

In this way the machining tool is always exactly parallel to the particular diagonal direction in which the machining line points at the machining point.

To avoid unnecessary slippage, it is also proposed that the transfer drive in the plotter module be made up of transport rollers in pairs, of which one pair is seated before the machining head of the plotter module and one pair behind it, so that the workpiece can be clamped between the transport rollers while it is transferred forward or backward.

Examples of embodiment of this are described.

The invention is explained in further detail below with reference to examples of embodiment.

The Figures show:

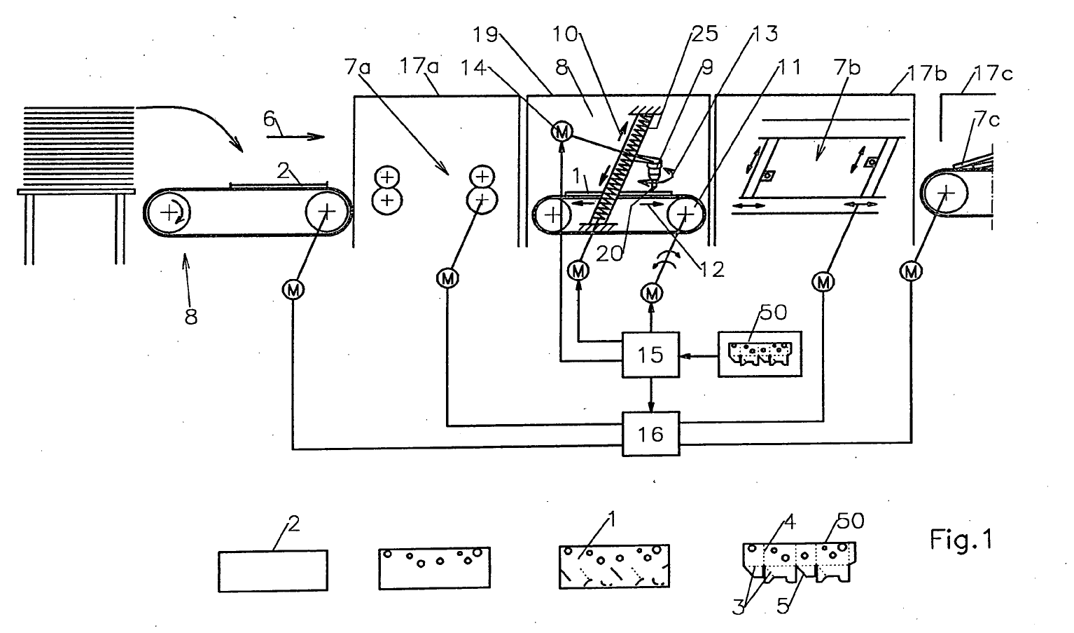

FIG. 1 a first example of embodiment of the machine;

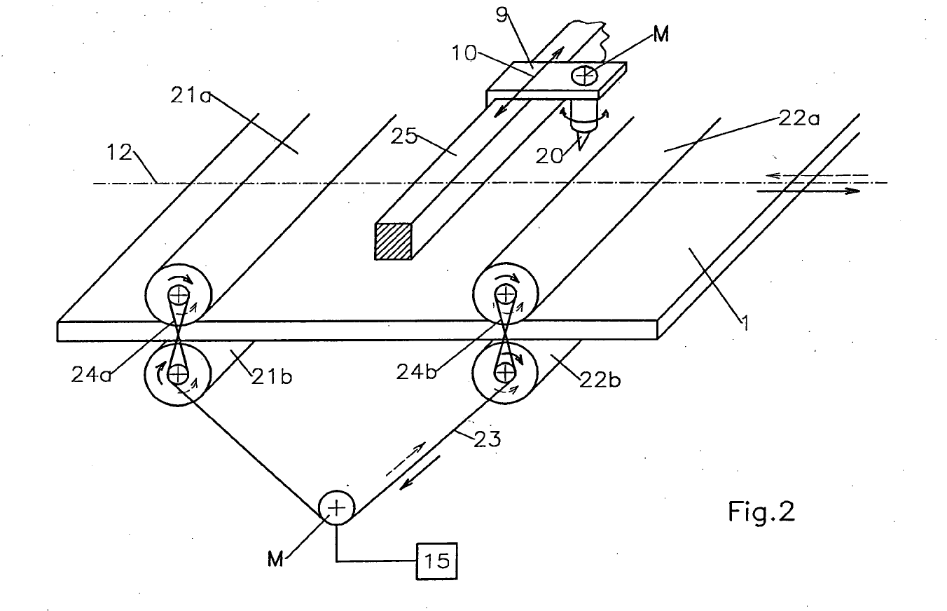

FIG. 2 a detailed view of a suitable transfer drive;

If not otherwise stated below, the following description always applies to all of the Figures.

The figures show clearly the method for producing blanks 1 made of cardboard or cardboard-like materials according to the present invention.

Boxes for selling specific products are ordinarily formed from these blanks 1.

The starting product for the present method is workpieces 2, of any initial shape originally.

They are usually corrugated board or cardboard blanks with a rectangular outline. These workpieces are finished into layouts 50 of the cardboard structures to be manufactured by longitudinal machining lines 3, transverse machining lines 4, and also diagonal machining lines 5.

The machining lines are usually cuts, slits, slots, scores, perforations, or folding lines.

As the lower subsidiary figure shows, machining lines 5 may appear in such blanks 1 that run neither exclusively in the longitudinal direction nor in the transverse direction.

The longitudinal direction is defined here by the so-called transfer drive direction 6, in which the workpieces 2 are fed through the individual machining steps 7a, 7b, 7c.

The present case involves a so-called in-line machine in which all transfer drive directions of the individual machining steps 7a-c lie on a single straight line.

It is important, then, for the machining lines 5 that run neither exclusively in the longitudinal direction nor exclusively in the transverse direction to be produced by a plotter device 8 that has a working head 9 movable in parallel above and relative to the plane of the workpiece that can travel at a given distance from the workpiece only in the transverse direction to any point on the particular machining line, can be activated for machining at any point on the workpiece, and is then driven in the activated state along the particular diagonal machining line 5 with controlled advance only in the transverse direction 10, while the workpiece at the same time is properly positioned in the longitudinal direction relative to the working head 9 of the plotter device 8 for machining, by means of the transfer drive 11 of the machine.

It is also important that the machining head 9, which also serves as the tool holder, can be made to travel only transverse to the workpiece by a suitable electric motor drive device, while the workpiece is positioned properly for machining by the combined control of the aforementioned motor drive device and the drive device for the transfer drive 11.

The longitudinal direction 12 of the plotter motion is therefore realized by appropriate control of the transfer drive 11.

In addition, the machining head has a rotational head 13 with its tool holder, so that the machining tool and the tool holder of the plotter device 8 can be rotated into any desired rotational position during the machining of the particular workpiece 2 that results from the vectorial addition of the speeds in the longitudinal 12 and transverse 10 directions.

The rotary head 13 has a rotational drive 14 suitable for this, to which control signals are fed from an electrical control 15 in exactly the same way as the transfer drive 11 and the drive for the transverse direction 10 to bring the desired diagonal machining line to this place on the processing machine.

The electrical control 15 for the plotter device has as its input the geometric data for the finished blank 1, so that the particular positioning of the workpiece 2 can take place through appropriate position sensors, while at the same time the necessary motions of the particular machining lines in the diagonal direction occur by controlling the motors of the longitudinal and transverse drives at the same time.

In the present case, the machining modules 17a, b, c are in direct succession with one another.

Since the plotter device, depending on the time consumed for machining, can naturally cause a backup in the area of the machine that is traversed by the workpiece before it, another electronic control 16 is provided by which at least the speeds of the preceding machining modules, only 17a here, can be slowed down so that the plotter module 19 is given the time needed for the particular machining of the workpiece 2.

It is important here for the coupling of the drives for the longitudinal and transverse directions on the plotter module to be such that the speed of the one motorized drive, for example for the longitudinal direction, is controlled as a function of the speed of the other motorized drive.

This is done conveniently by the master-slave principle, in which either the drive for the longitudinal direction or the drive for the transverse direction cans serve as the master, while the complementary drive assumes the slave function, and the reverse.

The reduction of the transfer speeds before the plotter module 19 involves particularly all of the drive units that are positioned between the intake station 18 and the input to the plotter module.

This does not necessarily apply to the machining modules following the plotter module, but can certainly be practical for obtaining predetermined machining rhythms.

In addition, FIG. 1 at the bottom shows different manufacturing stages of an originally rectangular workpiece 2, in which round holes are first introduced (first machining step), then diagonal cuts or perforation lines (further machining step), and then an appropriate outside contour that the box blank has to have (third machining step).

It is therefore definitely possible to complete these different machining steps in one and the same plotter device 8.

In the same way, it is possible to provide a separate plotter device 8 for each individual type of machining step.

FIG. 1 also shows a refinement in which the machining tool 20 on the plotter device 8 can rotate around a vertical axis into any desired rotational position.

A rotational drive 14 engaging with the rotary head 13 serves this purpose, which is controllable during the machining of the particular workpiece through the electrical control 15 for the plotter module in such a way that the particular rotational position is produced by the vectorial addition of the speeds in the longitudinal and transverse directions.

In addition to this, FIG. 1 shows still another refinement in which the machining tool 20 of the plotter module 19 is seated rigidly on a transverse bridge 25 connected to the machine frame, and can be made to travel on it only in the transverse direction 10.

This bridge, for reasons of statics, is rigidly connected to the machine frame at both ends.

However, other structural methods can also be found, for example telescopic drives.

In supplement hereto, FIG. 2 shows a special enhancement of the transfer drive in the plotter module 19.

To this end, pairs of transport rollers 21a,b and 22a,b are provided above and below the workpiece 2 respectively.

Each pair of these transport rollers 21a,b and 22a,b is seated before or beyond the machining head 9 of the plotter device 8, respectively, and clamps the workpiece 2 between them so that the drive is directed in the appropriate forward or backward transfer direction by suitable rotational control of the transport rollers 21a,b; 22a,b.

This is accomplished by having the two lower transport rollers 21b, 22b driven in the same direction of rotation by a common encircling drive belt, while the two upper transport rollers 21a, 22a are each driven in the same direction of action by a separate coupling belt 24a, 24b. The drive is zero-slip, for example by toothed belts.

### LIST OF REFERENCE SYMBOLS

1 Blank
2 Workpiece
3 Machining line, longitudinal
4 Machining line, transverse
5 Machining line, diagonal
6 Direction of transfer drive
7a First machining step
7b Second machining step
7c Third machining step
8 Plotter device
9 Working head, machining head, tool holder head
10 Transverse direction of motion of 9
11 Transfer drive on the plotter
12 Longitudinal direction on the plotter device
13 Rotary head
14 Rotational drive for 13
15 Electronic control for 8
16 Electronic control for the rest of the transfer drive
17a First machining module
17b Second machining module
17c Third machining module
18 Intake station
19 Plotter module
20 Machining tool
21a Upper transport roller
21b Lower transport roller
22a Upper transport roller
22b Lower transport roller
23 Joint drive belt
24 Coupler belt
24b Coupler belt
25 Transverse bridge
50 Layout

1. Method for production of cut-outs (1) for forming structures from cardboard-like materials, wherein flat workpieces (2) are shaped by at least one of longitudinal and transverse machine lines formed by at least one of cutting, scoring, perforating, punching, and folding lines to form a layout (50) of a cardboard structure to be manufactured; and formed by other machining lines (5) that run neither exclusively in the longitudinal direction nor exclusively in the transverse direction, wherein the longitudinal direction is defined by a transfer drive (6) by means of which the workpieces (2) are transported through individual machining steps (7a, b, c) of processing machines, and wherein other machining lines (5) that run neither exclusively in the longitudinal direction nor exclusively in the transverse direction, are generated by a plotter device (8) parallel to the workpiece (2) to be machined and movable relative to a plane thereof, whose working head (9) can travel at a given distance from the workpiece (2) only in the transverse direction (10) to any point on the other machining line (5) and can be activated to process at any point, and in an activated state is driven along the particular other machining line with controlled advance only in the transverse direction (10), the workpiece (2) at the same time being positioned in the longitudinal direction by means of a transfer drive (11) for machining relative to the working head (9) of the plotter device (8).

2. Method pursuant to claim 1, wherein the transfer drive (11) for the workpieces (2) operates in a single straight line.

3. Method pursuant to claim 1, wherein a machining tool (20) of the plotter device (8) during the machining of a particular workpiece (2) is rotatable into any selected rotational position that results from a vectorial addition of the velocities in the longitudinal and transverse directions at any time during the machining.

4. Device for production of cut-outs of cardboard-like material, the device comprising individual machining modules (17a, b, c) selecting from cutting, scoring, perforating, punching, and folding modules, arranged successively in a direction of machining of a workpiece (2), and with a transfer drive to transport the workpiece between an intake station (18) into the machine and the subsequent machining modules (17a, b, c), wherein at least one plotter module (19) is provided at which the workpiece (2) is controlled in position in the longitudinal direction of the production process by the transfer drive (11) of a processing machine, both forward and backward, and at the same time depending on the particular velocity transverse (10) to the longitudinal direction of a machining tool (20), that can travel in the plotter module (19) transverse to the longitudinal direction (12).

5. Device pursuant to claim 4, wherein the machining modules (17a, b, c, 19) follow one another directly, and during the forward/backward motions, at least the velocities of the prepositioned machining modules (17a) are reducible in time needed on the plotter module (19).

6. Device pursuant to claim 4, wherein the machining tool (20) on the plotter module (19) is rotatable around a vertical axis into a selected rotational position and is controllable during the machining of the particular workpiece in that the particular rotational position results from the vectorial addition of the velocities in the longitudinal and transverse directions.

7. Device pursuant to claim 4, wherein the transfer drive (11) in the plotter module comprises of transport rollers (21a, b; 22a, b) arranged in pairs above and below the workpiece, one pair of which (21a, b) in each case is seated in front of a working head (9) of the plotter module (19) and one pair behind the machining head of the plotter module, and all of the transport rollers (21a, b; 22a, b) are adapted to be driven simultaneously and with the same direction of action on the workpiece (2).

8. Device pursuant to claim 4, wherein machining tool (20) is seated on a transverse bridge (25) rigidly joined to the machine frame and is adapted to travel only in the transverse direction (10).
